(19) United States
(12) Patent Application Publication
(10) Pub. No.: US 2023/0196773 A1
(43) Pub. Date: Jun. 22, 2023

(54) OBJECT DETECTION DEVICE, OBJECT DETECTION METHOD, AND COMPUTER-READABLE STORAGE MEDIUM

(71) Applicant: MITSUBISHI HEAVY INDUSTRIES, LTD., Tokyo (JP)

(72) Inventors: Satoshi Iio, Tokyo (JP); Kiichi Sugimoto, Tokyo (JP); Kenta Nakao, Tokyo (JP)

(73) Assignee: MITSUBISHI HEAVY INDUSTRIES, LTD., Tokyo (JP)

(21) Appl. No.: 18/069,284

(22) Filed: Dec. 21, 2022

(30) Foreign Application Priority Data
Dec. 22, 2021 (JP) 2021-208634

(51) Int. Cl. G06V 20/40; G06V 10/75; G06V 10/25; G06T 7/20; G06T 5/00

(52) U.S. Cl. CPC G06V 20/46; G06V 10/751; G06V 10/25; G06T 7/20; G06T 5/006

(57) ABSTRACT

An object detection device includes: an image acquisition unit configured to acquire an image at a predetermined time interval; a first image processing unit configured to extract an object from the acquired image; a second image processing unit configured to extract a plurality of candidate areas of the object on a screen, based on a position of the object acquired in a previous frame of the image; a comparison unit configured to compare the object extracted by the first image processing unit and the candidate areas with an object extracted from an image in the previous frame of the image; and a specification unit configured to specify a candidate area of a current frame that matches the object extracted from the image in the previous frame, from the candidate areas, based on a comparison result of the comparison unit.

### CROSS-REFERENCE TO RELATED APPLICATIONS

The present application claims priority to and incorporates by reference the entire contents of Japanese Patent Application No. 2021-208634 filed in Japan on Dec. 22, 2021.

### FIELD

The present disclosure relates to an object detection device, an object detection method, and a computer-readable storage medium.

### BACKGROUND

There is an object detection device that analyzes an image acquired by a camera or the like, and that detects an object in the image. The object detection device includes a device that detects a plurality of objects and that tracks each of the objects.

Patent Literature 1 discloses an object tracking system including a plurality of detection units that each detects an object from a captured image and that outputs a detection result, and an integrated tracking unit that calculates position information on an object represented in a common coordinate system on the basis of the detection results output by each of the detection units. The integrated tracking unit outputs the calculated position information of the object in the common coordinate system. The detection unit converts the position information of the object in the common coordinate system to position information represented in an individual coordinate system unique to the camera that outputs an image from which an object is to be detected, tracks the object in the individual coordinate system, detects the object on the basis of the position information represented in the individual coordinate system, and converts the position information of the object detected on the basis of the position information represented in the individual coordinate system, to the position information represented in the common coordinate system.

### CITATION LIST

### Patent Literature

Patent Literature 1: Japanese Patent Application Laid-open No. 2020-107349

### SUMMARY

### Technical Problem

In a case where an object is detected, when a detection failure of the object occurs in a certain frame, there is a possibility that the same object is not determined appropriately, and the same object is detected as a different object. For example, even if a mobile device mounted with an object detection device is set such that a warning should not be issued for the same object (object that has already been detected), if the same object is detected as a different object, a warning is issued assuming that a new object is detected. Therefore, if the detection accuracy of the same object is low, work efficiency is reduced because a process for removing the warning is generated, or the work is temporarily interrupted by the alarm.

At least one embodiment of the present disclosure has been made to solve the problems described above, and an object of the present disclosure is to provide an object detection device, an object detection method, and a computer-readable storage medium that can prevent detection failure of an object and that can associate the same object at a high accuracy.

### Solution to Problem

An object detection device according to the present disclosure includes: an image acquisition unit configured to acquire an image at a predetermined time interval; a first image processing unit configured to extract an object from the acquired image; a second image processing unit configured to extract a plurality of candidate areas of the object in the image, based on a position of the object acquired in a previous frame of the image; a comparison unit configured to compare the object extracted by the first image processing unit and the candidate areas with an object extracted from an image in the previous frame of the image; and a specification unit configured to specify a candidate area of a current frame that matches the object extracted from the image in the previous frame, from the candidate areas, based on a comparison result of the comparison unit.

An object detection method according to the present disclosure includes: acquiring an image at a predetermined time interval; extracting an object from the acquired image; extracting a plurality of candidate areas of the object in the image, based on a position of the object acquired in a previous frame of the image; comparing the extracted object and the candidate areas with an object extracted from an image in the previous frame of the image; and specifying a candidate area of a current frame that matches the object extracted from the image in the previous frame, from the candidate areas, based on a result of the comparing.

A non-transitory computer-readable storage medium according to the present disclosure stores a program for causing a computer to execute: acquiring an image at a predetermined time interval; extracting an object from the acquired image; extracting a plurality of candidate areas of the object in the image, based on a position of the object acquired in a previous frame of the image; comparing the extracted object and the candidate areas with an object extracted from an image in the previous frame of the image; and specifying a candidate area of a current frame that matches the object extracted from the image in the previous frame, from the candidate areas, based on a result of the comparing.

### Advantageous Effects of Invention

The configuration described above can advantageously prevent detection failure of an object and associate the same object at a high accuracy.

### BRIEF DESCRIPTION OF DRAWINGS

FIG. 1 is a block diagram illustrating an example of an object detection device.

FIG. 2 is a flowchart illustrating an example of a process of the object detection device.

FIG. 3 is an explanatory diagram schematically illustrating an example of an image to be processed.

FIG. 4 is an explanatory diagram for explaining an example of a process of a first image processing unit.

FIG. 5 is an explanatory diagram for explaining an example of a process of a second image processing unit.

FIG. 6 is an explanatory diagram for explaining an example of a process of an image correction unit.

### DESCRIPTION OF EMBODIMENTS

Hereinafter, an embodiment according to the present disclosure will be described in detail with reference to the accompanying drawings. Note that the invention is not limited to the embodiment. Moreover, components in the following embodiment include components that can be easily replaced by a person skilled in the art or components that are substantially the same. Furthermore, the components described below can be combined with one another as appropriate. Still furthermore, when there are a plurality of embodiments, the embodiments may be combined with one another.

Object Detection Device

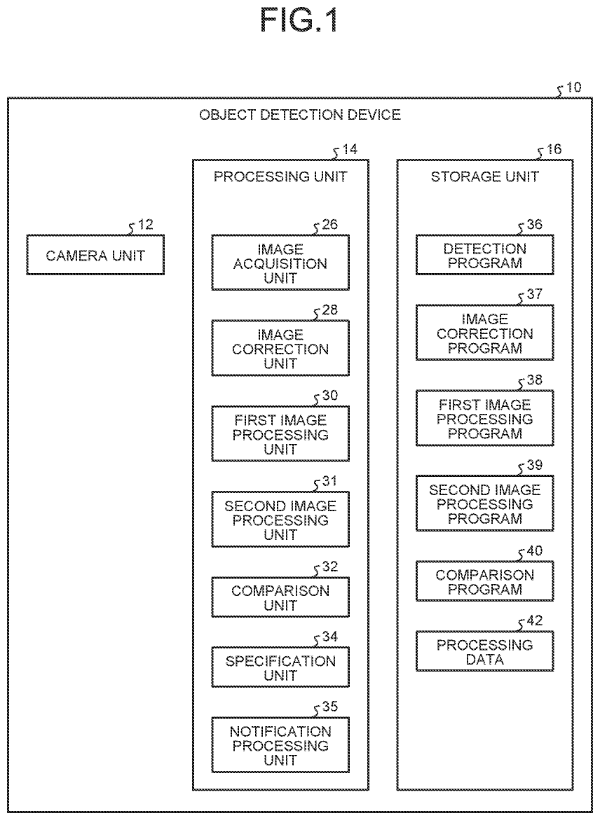

FIG. 1 is a block diagram illustrating an example of an object detection device. An object detection device 10 according to the present embodiment acquires an image, and detects an object from the acquired image. The object detection device 10 repeatedly detects an object in the image obtained in a certain time unit, and among a plurality of objects included in images at different times (different frames), specifies the same object. For example, the object detection device 10 is installed in a mobile body such as a vehicle and a flying vehicle, or in a building. Moreover, the object is not particularly limited, and may be objects of various categories such as human beings, machines, dogs, cats, vehicles, and plants.

As illustrated in FIG. 1, the object detection device 10 includes a camera unit 12, a processing unit 14, and a storage unit 16. The object detection device 10 may also include an input unit, an output unit, a communication unit, and the like. In this example, the output unit is a display that displays the analysis results of an image, and a speaker, a light-emitting device, a display, or the like that outputs an alarm on the basis of the detection result.

The camera unit 12 acquires an image included in an imaging area. The camera unit 12 acquires an image at a predetermined time interval. The camera unit 12 may continuously acquire images at a predetermined frame rate, or may acquire an image triggered by a certain operation.

The processing unit 14 includes an integrated circuit (processor) such as a central processing unit (CPU) and a graphics processing unit (GPU), and a memory serving as a work area. The processing unit 14 executes various processes by executing various computer programs using these hardware resources. Specifically, the processing unit 14 executes various processes by reading a computer program stored in the storage unit 16, developing the computer program in a memory, and causing the processor to execute the instruction included in the computer program developed in the memory. The processing unit 14 includes an image acquisition unit (image data acquisition unit) 26, an image correction unit 28, a first image processing unit 30, a second image processing unit 31, a comparison unit 32, and a specification unit 34. Prior to describing the units of the processing unit 14, the storage unit 16 will be described.

The storage unit 16 includes a nonvolatile storage device such as a magnetic storage device and a semiconductor storage device, and stores various computer programs and data. The storage unit 16 includes a detection program 36, an image correction program 37, a first image processing program 38, a second image processing program 39, a comparison program 40, and processing data 42.

Moreover, the data stored in the storage unit 16 includes the processing data 42. The processing data 42 includes image data acquired by the camera unit 12, and the position, the size, the comparison result, or the like of the object extracted from the image data. The processing data 42 can be classified and stored according to the positions of the objects. Moreover, the processing data 42 may include partially processed data. Furthermore, the processing conditions of each computer program and the like are stored in the storage unit 16.

The computer programs stored in the storage unit 16 include the detection program 36, the image correction program 37, the first image processing program 38, the second image processing program 39, and the comparison program 40. The detection program 36 integrates the operations of the image correction program 37, the first image processing program 38, the second image processing program 39, and the comparison program 40, and executes an object detection process. The detection program 36 executes a process of detecting an object from an image, comparing the object, and specifying each object. Moreover, the detection program 36 executes a notification process on the basis of the detection result.

The image correction program 37 performs image processing on an image acquired by the camera unit 12. The image processing includes various processes that improve the extraction accuracy of an object such as a distortion process.

The first image processing program 38 executes image processing on the image acquired by the camera unit 12, and extracts an object included in the image. Various programs can be used as the first image processing program 38, and a learned program that has learned to extract an object with a deep learning model can be used. The deep learning model can detect whether an object is included in an image, by setting bounding boxes or what are called anchors for an image, and by processing the feature amount in each of the anchors on the basis of the setting. The deep learning model to be used includes regions with convolutional neural networks (R-CNN), you only look once (YOLO), single shot multibox detector (SSD), and the like. The first image processing program 38 may also extract an object by pattern matching or the like. The first image processing program 38 calculates information on the area indicating the position where the object was extracted, and information indicating the characteristics within the area. The first image processing program 38 stores the extracted information in the processing data 42.

The second image processing program 39 determines a plurality of candidate areas, on the basis of the information on the position of the object that is extracted by the processing performed on the image acquired from the previous frame (previous point of time) of the image acquired by the camera unit 12. Each of the candidate areas is an area extracted as an area where the object may be located. The second image processing program 39 determines the candidate areas on the basis of the position information of the previous frame and the moving speed of the object. Moreover, the second image processing program 39 determines the candidate areas calculated by combining multiple moving speeds and multiple moving directions, while taking into account the change in the moving speed, the change in the moving direction, the change in the area size, and the change in the aspect ratio. On the basis of the position information of the object in the previous frame, the second image processing program 39 estimates the position of the object in the frame, by performing processing using a Kalman filter.

The comparison program 40 compares the object calculated in the previous frame with the object that is processed and calculated by the first image processing program 38 and the information on the candidate area calculated by the second image processing program 39. The comparison program 40 then specifies whether the same object is extracted from the frames, and specifies the identity of each object.

The detection program 36, the first image processing program 38, the second image processing program 39, and the comparison program 40 may be installed in the storage unit 16, by reading the detection program 36, the image correction program 37, the first image processing program 38, the second image processing program 39, and the comparison program 40 stored in a (non-transitory) computer-readable medium. The detection program 36, the first image processing program 38, the second image processing program 39, and the comparison program 40 may also be installed in the storage unit 16, by reading the detection program 36, the first image processing program 38, the second image processing program 39, and the comparison program 40 provided on the network.

The functions of the units of the processing unit 14 will now be described. Each of the units of the processing unit 14 performs a function by processing the computer program stored in the storage unit 16. The image acquisition unit 26 acquires data of the image acquired by the camera unit 12. The image correction unit 28 performs correction processing on the image acquired by the image acquisition unit 26. The first image processing unit 30 processes and executes the first image processing program 38. The first image processing unit 30 extracts an object from an image that is acquired by the image acquisition unit 26 and that is corrected by the image correction unit 28.

The second image processing unit 31 processes and executes the second image processing program 39. The second image processing unit 31 calculates the candidate areas, on the basis of the information on the position of the object calculated in the previous frame and the information on the set moving direction, moving speed, area size, and aspect ratio.

The comparison unit 32 is implemented by executing the process of the comparison program 40. The comparison unit 32 compares the detection result of the previous frame with the information processed by the first image processing unit 30 and the information within the candidate areas set by the second image processing unit 31, and outputs the information on the comparison result. The comparison unit 32 calculates the similarity between the object in the previous frame that has been compared, and each of the information processed by the first image processing unit 30 and information within the candidate areas set by the second image processing unit 31. In the present embodiment, the similarity is calculated using values from zero to one. As the value is closer to one, the similarity is increased, that is, there is a high possibility that the objects are the same object. The range of values of similarity is merely an example, and may be equal to or greater than one, or may be less than one. In this example, the comparison unit 32 calculates the similarity on the basis of pattern matching of the images in the area, the amount of change in the area, information on the feature amount obtained by filter processing, and the like. Specifically, the comparison unit 32 may calculate the intermediate feature amount of the deep learning model, for each of the areas to be compared, and may use the reciprocal of the difference between the Euclidean distances of the feature amount as the similarity. Alternatively, as in Siamese Network or the like, the comparison unit 32 may directly calculate the distance between the two areas by the deep learning model, and use the reciprocal of the calculated distance as the similarity. Moreover, the comparison unit 32 may calculate the similarity on the basis of pattern matching of the images in the area, the amount of change in the area, information on the feature amount obtained by filter processing, and the like.

The specification unit 34 is implemented by executing the process of the comparison program 40. On the basis of the comparison result of the comparison unit 32, the specification unit 34 specifies the same object (same subject) in the frames. On the basis of the comparison result of the comparison unit 32, the specification unit 34 specifies the candidate area in the current frame that matches the object extracted from the image in the previous frame, from the candidate areas. The specification unit 34 associates the object in the previous frame with the object in the current frame detected by the first image processing unit 30, and the candidate areas of the current frame calculated by the second image processing unit 31, that is, the specification unit 34 determines the area in the current frame where the same object as that in the previous frame is captured. To determine the same object, an association technique such as the Hungarian algorithm may be used, and the object with the highest similarity (or the shortest distance if the distance between the feature amounts described above is used as the similarity) may be selected, when the entire combination is taken into consideration. Moreover, to determine the optimal combination, if the distance is equal to or greater than a threshold, it is possible to consider that there is no similar feature and eliminate the candidate.

A notification processing unit 35 is implemented by executing the process of the detection program 36. The notification processing unit 35 executes the notification process on the basis of the specification result of the specification unit 34. The notification processing unit 35 performs a process of notifying the user of the specified result, and when the specification result satisfies the criteria of the notification, performs a process of notifying the user of the specification result, and the like. The criteria of the notification include when the object is within the set range or when a new object is detected. Moreover, it is possible to set not to notify the user, when the object that is specified in the past and that is excluded from the object to be notified, enters the set range. Note that, while in the present embodiment, the notification processing unit 35 is provided, the object detection device 10 may be a device that does not include the notification processing unit 35 and performs the detection process.

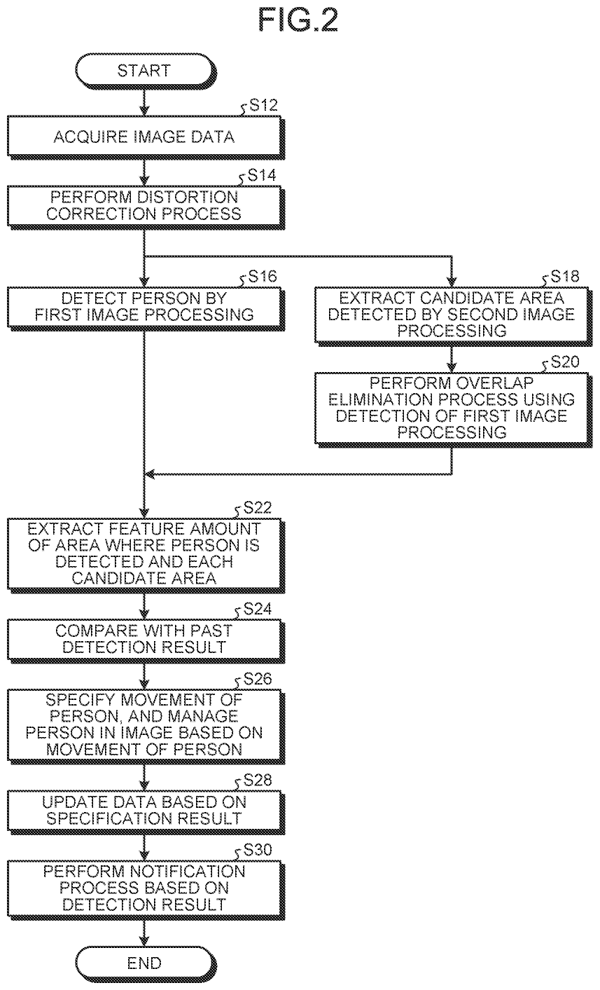

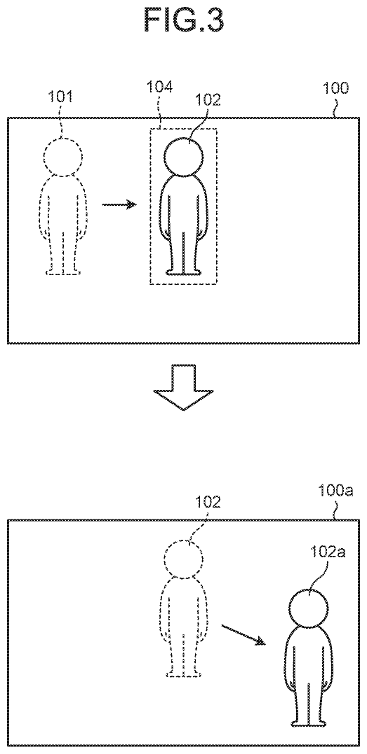

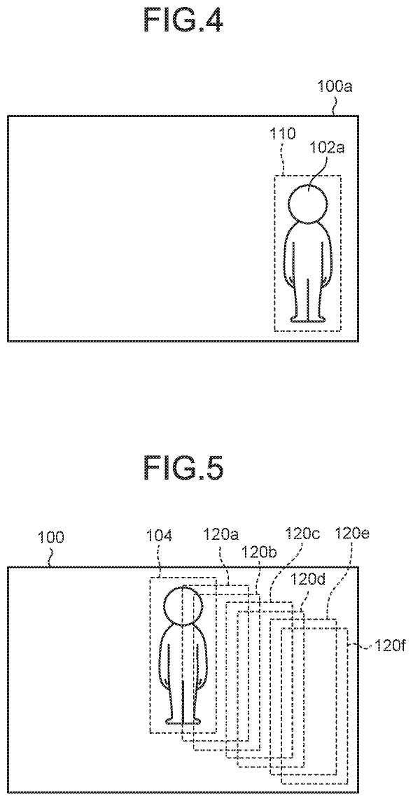

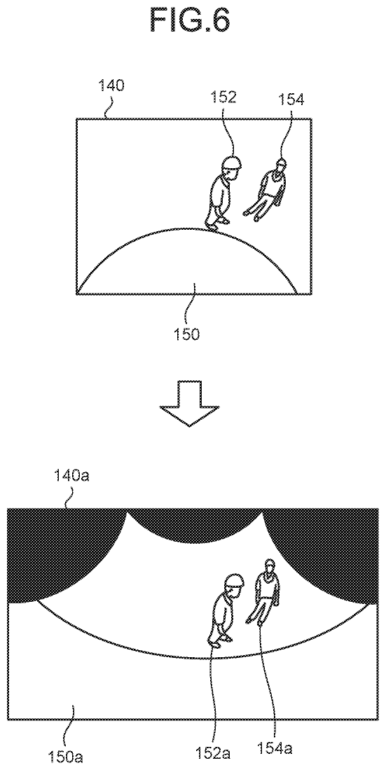

Next, with reference to FIG. 2 to FIG. 6, an example of the process of the object detection device 10 will be described. FIG. 2 is a flowchart illustrating an example of a process of the object detection device. FIG. 3 is an explanatory diagram schematically illustrating an example of an image to be processed. FIG. 4 is an explanatory diagram for explaining an example of a process of a first image processing unit. FIG. 5 is an explanatory diagram for explaining an example of a process of a second image processing unit. FIG. 6 is an explanatory diagram for explaining an example of a process of an image correction unit. In the following, it is assumed that the object is a human being.

The object detection device 10 acquires image data acquired by the camera unit 12 through the image acquisition unit 26 (step S12). In the present embodiment, as illustrated in FIG. 3, an image 100 is acquired in the previous frame, and then an image 100a is acquired in the frame to be processed. In the image 100 of the previous frame, a person 102 is in an area 104. In the image 100a of the frame to be processed, the person 102 has moved to the position of a person 102a. Moreover, a person 101 in the image 100 is the position of the person 102 in the image of the frame before last.

The object detection device 10 performs a distortion correction process by the image correction unit 28 (step S14). In the present embodiment, while the distortion correction process is performed as an example, the process executed by the image correction unit 28 is not limited to the distortion correction. The object detection device 10 transmits the image to which image processing is applied, to the first image processing unit 30 and the second image processing unit 31. The object detection device 10 performs the processing of the first image processing unit 30 and the processing of the second image processing unit 31 in parallel.

The object detection device 10 extracts an object by the first image processing unit 30 (step S16). Specifically, as illustrated in FIG. 4, in the case of the image 100a, the object detection device 10 performs processing on the image 100a, and extracts an area 110 where the person 102a is displayed.

The object detection device 10 extracts the candidate areas detected by the second image processing unit 31 (step S18). Specifically, as illustrated in FIG. 5, in the case of the image 100a, based on the area 104 extracted on the basis of the object 102 in the image 100 of the previous frame, the object detection device 10 extracts a plurality of candidate areas 120a, 120b, 120c, 120d, 120e, and 120f. The second image processing unit 31 processes the information on the image to which the position of the object is associated in time series, using a Kalman filter, and estimates the moving speed of the object. Moreover, based on the estimated moving speed, the second image processing unit 31 calculates multiple moving speeds when the moving speed is changed. Based on the area 104, the second image processing unit 31 calculates multiple moving directions. The second image processing unit 31 combines each of the calculated moving speeds and each of the moving speeds, and calculates the candidate areas based on the position of the area 104. In the present embodiment, there are six candidate areas. However, the number of candidate areas is not limited thereto. If the estimated speed is greater than a threshold, the second image processing unit 31 may set the candidate area by setting multiple speeds. If the estimated speed is equal to or less than a threshold, the second image processing unit 31 may set the candidate area by setting a fixed error at the position instead of the speed.

The object detection device 10 performs an overlap elimination process using the detection result of the first image processing unit 30, by the second image processing unit 31 (step S20). The second image processing unit 31 detects whether there is any area overlapping with the area of the object 102a detected in the image 100a by the first image processing unit 30, among the candidate areas. The second image processing unit 31 then eliminates the area overlapping with the area of the object detected by the first image processing unit 30, from the candidate areas. In the case of the image 100 illustrated in FIG. 5, the second image processing unit 31 determines that the candidate area 120f overlaps largely with the area 110, and eliminates the candidate area 120f from the candidate areas. In addition to when the area of the object 102a completely matches with the candidate area, the second image processing unit 31 may determine that the area matches with the candidate area, when the area is overlapping with the candidate area at a ratio equal to or greater than the threshold. The threshold is the ratio that determines whether the determination process is performed on the same object.

The object detection device 10 extracts a feature amount of the area where a person is detected and each of the candidate areas, by the comparison unit 32 (step S22). The object detection device 10 extracts information on the feature amount that serves as the basis for comparison, for the area 110 in the image 100a and the areas corresponding to the candidate areas 120a, 120b, 120c, 120d, 120e, and 120f in the image 100a.

The object detection device 10 compares the result with the past detection result by the comparison unit (step S24). In the present embodiment, the object detection device 10 compares the feature amount of the area 104 in the image 100 with the feature amount of the area 110 in the image 100a and each of the areas corresponding to the candidate areas 120a, 120b, 120c, 120d, 120e, and 120f in the image 100a.

On the basis of the comparison result, the object detection device 10 specifies the movement of a person, and manages the person in the image on the basis of the movement, by the specification unit 34 (step S26). On the basis of the comparison result calculated by the comparison unit 32, the specification unit 34 specifies the similarity between the object in the image 100 and the object in the image 100a, and specifies the movement of the object, to specify the movement of the position of the object, or the person in the present embodiment. The specification unit 34 determines whether the person in the previous frame is in the current frame or whether a new person is in the current frame. Specifically, the specification unit 34 compares the similarity of the person area in the previous frame with the person area in the current frame and the person area candidates, obtains the combination with the highest similarity, and calculates whether the person in the previous frame is associated with the person area in the current frame or any one of the person area candidates. If the person area in the previous frame does not associate with anything, the specification unit 34 determines that the person is hiding behind something in the current image frame or that the person has moved out from the image. If the person area in the current frame does not associate with anything, the specification unit 34 determines that a new person has appeared. If the person area candidates in the current frame do not associate with anything, the specification unit 34 determines that the area is not the person area and eliminates the area.

The object detection device 10 updates the data on the basis of the specification result (step S28). Specifically, the object detection device 10 updates the information on the area of the object in the image 100a corresponding to the previous frame during the next process. Moreover, the object detection device 10 updates the information on the moving speed and the moving direction on the basis of settings.

The object detection device 10 performs a notification process on the basis of the detection result by the notification processing unit 35 (step S30).

The object detection device 10 extracts an object by the first image processing unit 30, extracts a plurality of candidate areas to which the object may have moved on the basis of the detection result of the previous frame by the second image processing unit 31, and performs a process of determining whether there is the same object as that in the previous frame for each of the extraction results. Consequently, it is possible to prevent detection failure of the same object, and detect the same object at a high accuracy. That is, even if the same object cannot be extracted by the first image processing unit 30, it is possible to specify the same object from the candidate areas. Moreover, by extracting the candidate areas by the second image processing unit 31, it is possible to further reduce the possibility of detection failure.

Furthermore, when the object extracted by the image processing overlaps with the candidate area, the object detection device 10 can eliminate the candidate area. Accordingly, it is possible to reduce the candidate areas at which the feature amount calculation and the similarity calculation are to be performed, and reduce the calculation process. Note that, to reduce the amount of calculation, although it is preferable to perform the overlap elimination process at step S20 in FIG. 2, the elimination process may not be performed.

Still furthermore, the object detection device 10 may be configured to store the history of identity determination results (whether a current object has been extracted as the object or extracted in the candidate area), and may be configured not to perform association as the same object assume that there is no object in the detected area and the characteristics of the background are detected if association based on the candidate area continues for a specified number of times (for example, twice) or more.

By performing the distortion correction process as the image correction process, the object detection device 10 can increase the detection accuracy.

Specifically, as illustrated in FIG. 6, by performing the distortion correction process on an image 140 including a moving body 150 and persons 152 and 154, and creating an image 140a, it is possible to correct the distortion generated by the characteristics of the camera unit 12, and to prevent a moving body 150a and persons 152a and 154a from being distorted by the viewing angle position. Consequently, for example, even in an image taken by the camera unit 12 using a fish eye lens or a wide angle lens and in which the difference in distortion is increased by the position, it is possible to detect the same object in the image at a high accuracy. That is, it is possible to suppress the shape of the object from being changed by the position on the image, and increase the detection accuracy and the accuracy of specifying the same object by the first image processing unit 30.

### REFERENCE SIGNS LIST

10 Object detection device

12 Camera unit

14 Processing unit

16 Storage unit

26 Image acquisition unit

28 Image correction unit

30 First image processing unit

31 Second image processing unit

32 Comparison unit

34 Specification unit

36 Detection program

37 Image correction program

38 First image processing program

39 Second image processing program

40 Comparison program

42 Processing data

1. An object detection device, comprising:
an image acquisition unit configured to acquire an image at a predetermined time interval;
a first image processing unit configured to extract an object from the acquired image;
a second image processing unit configured to extract a plurality of candidate areas of the object in the image, based on a position of the object acquired in a previous frame of the image;
a comparison unit configured to compare the object extracted by the first image processing unit and the candidate areas with an object extracted from an image in the previous frame of the image; and
a specification unit configured to specify a candidate area of a current frame that matches the object extracted from the image in the previous frame, from the candidate areas, based on a comparison result of the comparison unit.

2. The object detection device according to claim 1, wherein the first image processing unit is configured to extract an object by a learned program that has performed machine learning.

3. The object detection device according to claim 1, wherein based on the position of the object acquired in the previous frame of the image, the second image processing unit is configured to extract a position, as a candidate area, created based on information on past movement history.

4. The object detection device according to claim 3, wherein the second image processing unit is configured to process the information on the past movement history using a Kalman filter, estimate a moving speed, and determine the candidate area based on the estimated moving speed.

5. The object detection device according to claim 1, further comprising an image correction unit configured to perform distortion correction on the image acquired by the image acquisition unit.

6. The object detection device according to claim 1, wherein the second image processing unit is configured to eliminate a candidate area overlapping with the position of the object extracted by the first image processing unit from an object to be processed.

7. An object detection method, comprising:
acquiring an image at a predetermined time interval;
extracting an object from the acquired image;
extracting a plurality of candidate areas of the object in the image, based on a position of the object acquired in a previous frame of the image;
comparing the extracted object and the candidate areas with an object extracted from an image in the previous frame of the image; and
specifying a candidate area of a current frame that matches the object extracted from the image in the previous frame, from the candidate areas, based on a result of the comparing.

8. A non-transitory computer-readable storage medium storing a program for causing a computer to execute:
acquiring an image at a predetermined time interval;
extracting an object from the acquired image;
extracting a plurality of candidate areas of the object in the image, based on a position of the object acquired in a previous frame of the image;
comparing the extracted object and the candidate areas with an object extracted from an image in the previous frame of the image; and
specifying a candidate area of a current frame that matches the object extracted from the image in the previous frame, from the candidate areas, based on a result of the comparing.
